(19) United States
(12) Patent Application Publication
(10) Pub. No.: US 2002/0166620 A1
(43) Pub. Date: Nov. 14, 2002

(54) High temperature stable piezoelectric polymer films

(76) Inventors: Jerry I. Scheinbeim, Somerset, NJ (US); Qiong Gao, Somerville, NJ (US)

Correspondence Address: HOFFMANN & BARON, LLP, 6900 JERICHO TURNPIKE, SYOSSET, NY, 11791, US

(21) Appl. No.: 09/805,525

(22) Filed: Mar. 13, 2001

(51) Int. Cl. C09J 1/00

(52) U.S. Cl. 156/160; 156/272.2; 156/229

(57) ABSTRACT

Improved polarized materials are formed from dry powder blends of materials that demonstrate piezoelectric properties. Specifically, at least one nylon and at least one vinylidene containing polymer are mixed together to form a blended polarized material. Single-layered and multi-layered films including the blended polarized material, as well as methods for their manufacture are also disclosed.

### FIELD OF THE INVENTION

This invention relates to polarized materials. More specifically, this invention relates to improved piezoelectric single layer and multi-layer films and methods for their manufacture.

### BACKGROUND OF RELATED TECHNOLOGY

A piezoelectric material is a material that will produce an electric polarization in response to a mechanical stress. Such materials are extensively used in transducers to convert a mechanical stimulus such as a vibration into an electric signal.

There are several polymers that are known to produce a piezoelectric response under various conditions. Poly(vinylidene fluoride) or PVDF has been found to produce the highest piezoelectric response of any known polymer at room temperature. However, while PVDF produces a high remanent polarization, it does not exhibit thermal stability of the polarization at high temperatures in the same manner as materials such as odd-numbered nylons. The lack of stability of polarization demonstrated by PVDF at high temperatures limits the potential uses for PVDF.

Attempts have been made to provide a material capable of producing a piezoelectric response similar to PVDF that exhibits more favorable properties. Blending of materials is one method through which a material with improved piezoelectric properties may be obtained. The piezoelectric properties of several polymer blends that include PVDF have been studied. The blends have incorporated materials known to be miscible with PVDF such as poly(methyl methacrylate) or PMMA, poly(ethyl methacrylate) or PEMA, poly(methyl acrylate) or PMA, poly(ethyl acrylate) or PEA, poly(vinyl methyl ketone) or PVMK, poly(tetramethylene adipate) or PTMA, poly(vinyl acetate) or PVA, poly(vinyl fluoride) or PVF, poly(trifluoroethylene) or PTrFE, poly(N-vinyl-2-pyrrolidone), poly(N-methyl ethylenimine), poly(N,N-dimethyl acrylamide), poly-ε-caprolactone or PCL, poly-3-hydroxybutyrate or PHB, and poly(neopentyl adipate).

The polymer blends of the above materials that have been studied, do not demonstrate the high remanent polarization of the pure PVDF material. The piezoelectric properties of the blends tend to decrease dramatically as the proportion of PVDF is decreased. In fact, a blend of PVDF with more than 50% by weight of PMMA exhibits practically no remanent polarization. The blends of PVDF with the other polymers produced similar results.

U.S. Pat. No. 5,336,422 to Scheinbeim et al. discloses a method of producing a piezoelectric film formed from a blend of either vinylidene containing polymers or a blend of odd-numbered nylons. These materials were thermally stable at temperatures up to about the melt temperatures of the film. However, the manufacture of these films required the use of a polarization solvent and while the materials were stable at high temperatures, the blends did not result in an increase in their piezoelectric response.

U.S. Pat. No. 5,356,500 to Scheinbeim et al. discloses a method of producing a piezoelectric laminate film that produces up to a 40% percent increase in the piezoelectric response as compared to a film of only one material. This method includes laminating at least two separate films together such as a film of PVDF and a film of nylon-11. This multi-layered film results in the increase in remanent polarization. However, this film does not exhibit high temperature stability of the polarization.

There is a need for a polarized material that has increased piezoelectric and ferroelectric responses and retains these properties at high temperatures. The combination of these properties in a single material would increase the variety of applications including high temperature applications.

There is also a need for a material that incorporates an increased piezoelectric response and a high temperature stability in a single-layered film, whereby manufacturing methods can be simplified and increases in cost efficiency can be obtained.

### SUMMARY OF THE INVENTION

One aspect of the present invention provides a polarized material that demonstrates an increased remanent polarization and is stable at high temperatures. The material, which retains its polarization at temperatures up to at least about 160° C. and can be substantially free of solvents, is a blend of a vinylidene-containing polymer and at least about 10% by weight of the blend of an odd-numbered nylon or an odd-odd numbered nylon. Blends incorporating more than one vinylidene-containing polymer and more than one odd-numbered nylon or odd-odd numbered nylon are also contemplated.

Examples of vinylidene-containing polymers include, but are not limited to, poly(vinylidene fluoride) (PVDF) and poly(vinylidene fluoride/vinyl trifluoride) copolymer (poly(VF₂-VF₃)). Examples of odd-numbered and odd-odd numbered nylons include, but are not limited to, Nylon-3, Nylon-5, Nylon-7, Nylon-11, Nylon 5-7, and Nylon 3-5.

The blended polarized material exhibits a remanent polarization that is greater than any of the component materials alone. In this sense, the blended polarized material of the present invention can be said to be synergistic with respect to its remanent polarization. Desirably, the blend is a 50:50 by weight blend and includes poly(VF2-VF3) and Nylon-11. More desirably, the blend is a 50:50 by weight blend and includes PVDF and Nylon-11.

Another aspect of the present invention provides a method for producing a piezoelectric film that demonstrates an increased remanent polarization and is stable at high temperatures. The steps of the method include melting a fine powder blend of a vinylidene-containing polymer and at least 10% by weight of the blend of an odd-numbered or odd-odd numbered nylon, forming the material into a film, and polarizing the film. The blend used to form the film, which is stable up to about 160° C., can be substantially free of solvents. The method of producing the film may additionally include the steps of quenching the film, uniaxially cold drawing the film, and annealing the film after the polarization which may be in a field of up to about 220 MV/m. The fine powder blend can be prepared by mixing the vinylidene-containing polymer and the nylon in a freezer/mill at liquid nitrogen temperature for a sufficient time to ensure uniformity of the blend. For example, approximately thirty minutes is usually sufficient, depending on the quantity and type of materials being blended.

A further aspect of the invention provides a film produced from the above method, which film has an increased remanent polarization and high temperature stability.

A still further aspect of the present invention provides a multi-layered film produced by combining layers of blends produced by the above method, including separate layers of the above blends, which film also demonstrates an increased remanent polarization and high temperature stability.

### BRIEF DESCRIPTION OF THE DRAWINGS

FIG. 1 is a schematic diagram of the process useful in preparing a film of the present invention. This figure also includes a representation of the film showing the direction of stretching with respect to the placement of electrodes used to supply the current.

FIG. 2 is a schematic representation of an apparatus for poling a film of the present invention.

FIGS. 3A and 3B are graphs showing a comparison of the piezoelectric properties of films containing Nylon-11, PVDF, and blends of Nylon-11 and PVDF.

### DETAILED DESCRIPTION OF THE INVENTION

For purposes of this invention, high temperature thermal stability is defined as the ability of a material to retain substantially its piezoelectric properties at high temperatures.

The present invention relates to a polarized material that provides increased piezoelectric properties with high temperature stability. The polarized material of this invention includes a blend of at least one vinylidene-containing polymer such as poly(vinylidene fluoride) (PVDF) and poly(vinylidene fluoride/vinyl trifluoride) copolymer (poly(VF₂-VF₃)) and at least one odd-numbered nylon such as Nylon-3, Nylon-5, Nylon-7, Nylon-11, or an odd-odd numbered nylon such as Nylon 5-7 or Nylon 3-5. The polarized material may alternatively include a blend of PVDF and poly(VF₂-VF₃) as well as a blend of more than one odd-numbered or odd-odd numbered nylon. The polarized material can be prepared without the use of a polarization solvent and is thermally stable up to at least about 160° C. The components may be mixed in various amounts, preferably with more than 10% by weight odd-numbered or odd-odd numbered nylon, and most preferably a 50:50 by weight blend.

The blended polarized material of the present invention produces a significant increase in piezoelectric properties, i.e. remanent polarization, as compared to the component materials individually. A polarized material that includes a 50:50 by weight blend of Nylon-11 and poly(VF₂-VF₃)(80/20 mol %) displays a remanent polarization that is 100% greater than that of the poly(VF₂-VF₃)(80/20 mol %) and 50% greater than that of Nylon-11. When the polarized material includes a 50:50 by weight blend of Nylon-11 and PVDF, it displays a remanent polarization that is 70% larger than that of either component.

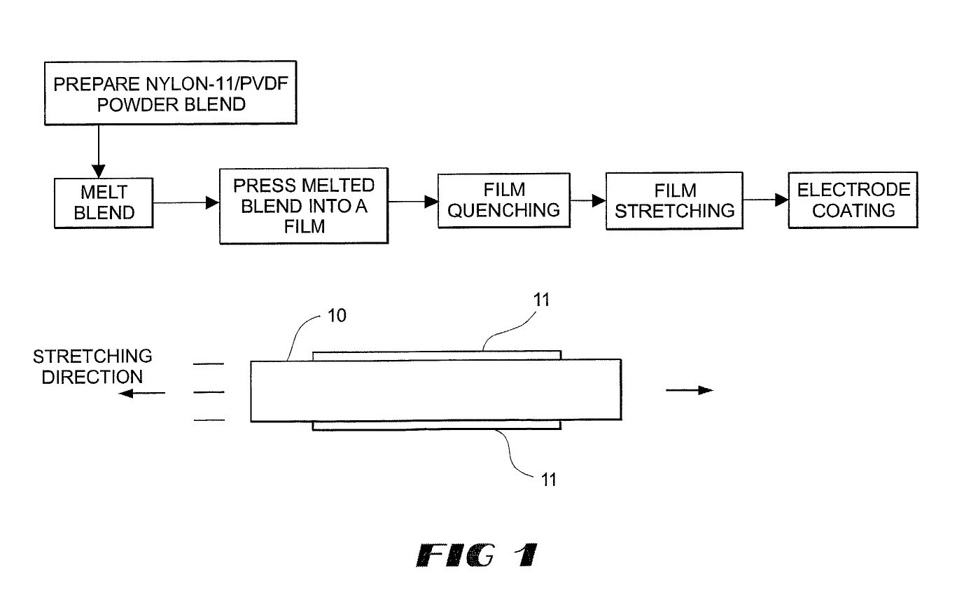

A desired method of preparing a single-layered piezoelectric film is shown in FIG. 1. The method includes preparing a powder blend of Nylon-11 and PVDF, melting the blend, pressing the melted blend into a film 10, quenching the film, stretching the film, and poling the film. The direction of stretching is perpendicular to the placement of electrodes 11 on either side of the blended film 10.

The polarized material may be formed into a single-layered film capable of substantially retaining its piezoelectric properties at high temperatures. The film is prepared from a fine powder blend of at least one vinylidene-containing polymer and at least one odd-numbered or odd-odd numbered nylon as described above, and is desirably prepared without the use of a solvent. The fine powder blend may be prepared by first preparing a powder of the odd-numbered or odd-odd numbered nylon by impacting pellets of the nylon or a combination of different nylons in a freezer/mill at liquid nitrogen temperature, adding the PVDF or poly(VF₂-VF₃) powder (or a mixture of both), and mixing the blend in the freezer/mill for a sufficient time to achieve a uniform mixture, e.g. about a half hour.

The prepared powder blend can then be formed into a film by melting the powder at temperatures up to about 210° C. and pressing. The thickness of the film can vary depending on its intended application. Generally, the thickness may vary from about 10 μm to about 35 μm, desirably from about 20 μm to about 30 μm. The melted film may then be quenched in an ice water bath. The film may then be drawn, which increases the piezoelectric properties. The films are preferably uniaxially cold-drawn at room temperature at about a 3:1 draw ratio.

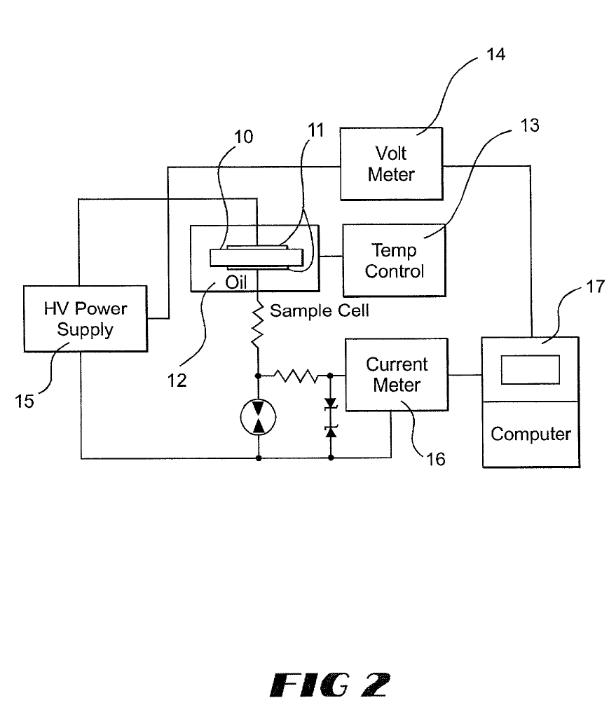

The films can then be placed in an electric field to induce polarization. FIG. 2 demonstrates an apparatus useful for poling. The blended film 10 may be placed in an oil bath 12 to reduce corona discharge during poling. Electrodes 11 placed on either side of the film 10, provide an electric field supplied by a power supply 15. The voltage and current are measured by a volt meter 14 and current meter 16, respectively. A computer 17 is provided for analysis and recordation of data. The temperature may be controlled by a heating/cooling device 13 as desired. The poling may be carried out at room temperature in a field of up to about 220 MV/m, preferably in a field above 160 MV/m. After poling, the film may additionally be annealed. Annealing is performed at temperatures up to the melting temperature of the material. Preferably, the annealing will be conducted in a vacuum at 160° C. for a sufficient time, e.g. about two hours.

A multi-layered film may also be produced by laminating two or more films produced by the above process.

### EXAMPLE

Nylon-11 pellets and PVDF powder were obtained from Rilsan Corporation and Sotex Polymer Corporation, respectively. Nylon-11 powder was obtained by impacting the pellets in a Spex mill at liquid nitrogen temperature. The nylon powder was then mixed with the PVDF powder in the Spex mill, also at liquid nitrogen temperature for approximately a half hour. The mixed powder was vacuum dried at 100° C. for twelve hours, then sandwiched between aluminum foils in a hot press at 210° C. It was then melted and quenched in an ice water bath. The melt-quenched films were uniaxially drawn from 1:1 to 3.5:1 in steps of 0.5 with a draw speed of 2.56 cm/min at room temperature. The thickness of the films varied from ˜30 μm to 18 μm for the undrawn film, respectively.

Gold electrodes were then evaporated under high vacuum on opposing sides of the films. The shape of the electrodes were rectangular and the area was 40 mm² (4 mm×10 mm).

Poling was carried out at room temperature by application of a triangular shaped field at a very low frequency of 1/640 Hz. The samples were immersed in a silicone oil bath during poling to reduce corona discharge. The silicon oil was continuously purged using dried air to decrease the conductivity and increase the maximum dielectric strength of Nylon-11 which decreases with adsorbed water. A maximum poling field of 220 MV/m was used for the blend.

As a comparison, blends of PVDF and Nylon-11 were prepared using a solution method for mixing as opposed to the powder blend. The table below shows a comparison of several piezoelectric properties of films prepared with only Nylon-11, only PVDF, solution blends, and the powder blends of the present invention. The properties listed are as follows: remanent polarization (Pᵣ), coercive field (E_{c}), Young's Modulus, piezoelectric stress constant (d₃₁), piezoelectric strain constant (e₃₁), and the dielectric constant.

| | | | Solution | |
|---|---|---|---|---|
| | | | Blend | |
| | | | Nylon-11/ | Powder Blend |
| | Nylon-11 | PVDF | PVDF | Nylon-11/PVDF |
| Pᵣ (mC/m²) | 51 | 52 | 65 | 87 |
| E_{c} (mC/m²) | 69 | 64 | 75 | 75 |
| Young's Modulus | 4.5 | 2.2 | 2.96 | 3.15 |
| C(Gpas) | | | | |
| d₃₁ | 2.8 | 25.2 | 4.28 | 6.96 |
| e₃₁ | 6.2 | 71.0 | 12.65 | 22.43 |
| Dielectric Constant | 2.8 | 12.0 | 5.68 | 5.76 |

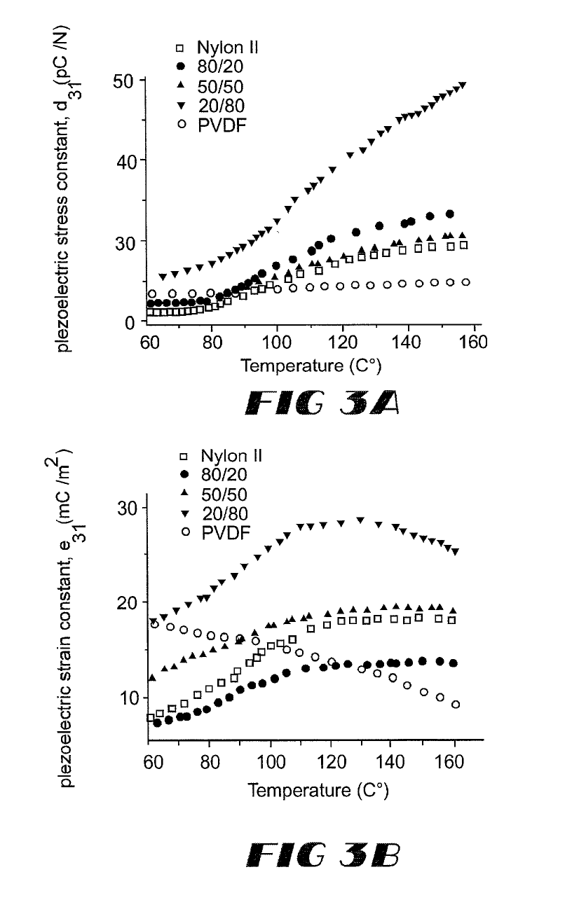

FIGS. 3A and 3B show a comparison of both d₃₁ and e₃₁, respectively, for films made of only Nylon-11, only PVDF, and blends of the materials at ratios of 20:80, 50:50, and 80:20 by weight of the blend. The above table and FIG. 3 both show the improvement in piezoelectric properties with the blends as opposed to the component materials separately. FIG. 3 also shows that the properties are maintained as the temperature approaches 160° C.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

What is claimed is:

1. A stable polarized material comprising a blend comprising a vinylidene-containing polymer and at least 10% by weight of the blend of a nylon selected from the group consisting of odd-numbered nylons and odd-odd numbered nylons, wherein said material retains its polarized properties up to about 160° C.

2. The polarized material of claim 1, wherein said blend is substantially free of solvents.

3. The polarized material of claim 1, wherein said vinylidene-containing polymer is selected from the group consisting of poly(vinylidene fluoride) (PVDF), poly(vinylidene fluoride/vinyl trifluoride) copolymer (poly(VF₂-VF₃)), and blends thereof.

4. The polarized material of claim 1, wherein said nylon is selected from the group consisting of Nylon-3, Nylon-5, Nylon-7, Nylon-11, Nylon 5-7, Nylon 3-5, and blends thereof.

5. The polarized material of claim 1, wherein said blend has a remanent polarization that is greater than that of either said vinylidene-containing polymer or said nylon separately.

6. The polarized material of claim 1, wherein said blend has a remanent polarization that is at least 50% greater than that of either said vinylidene-containing polymer or said nylon separately.

7. The polarized material of claim 1, wherein said blend has a remanent polarization that is at least 70% greater than that of either said vinylidene-containing polymer or said nylon separately.

8. The polarized material of claim 1, wherein the blend comprises a 50:50 by weight blend of said vinylidene-containing polymer and said nylon.

9. The polarized material of claim 1, wherein said vinylidene-containing polymer is poly(VF₂-VF₃) and said nylon is Nylon-11.

10. The polarized material of claim 1, wherein said vinylidene-containing polymer is PVDF and said nylon is Nylon-11.

11. A stable polarized material comprising a blend comprising a vinylidene-containing polymer and at least 10% by weight of the blend of a nylon selected from the group consisting of odd-numbered nylons and odd-odd numbered nylons, wherein said material retains its polarized properties up to about 160° C. and said blend is substantially free of solvents.

12. A method for providing a piezoelectric film comprising the following steps:
a) melting a fine powder blend comprising a vinylidene-containing polymer and at least 10% by weight a nylon selected from the group consisting of odd-numbered nylons and odd-odd numbered nylons,
b) forming the material into a film, and
c) polarizing the film.

13. The method of claim 12, wherein said blend is substantially free of solvent

14. The method of claim 12, wherein the step of forming said film further comprises a step of quenching said film.

15. The method of claim 12, wherein the step of forming said film further comprises a step of uniaxially cold drawing said film.

16. The method of claim 12, wherein said polarizing is in a field of 220 MV/m.

17. The method of claim 12, further comprising a step of annealing said film.

18. The method of claim 12, wherein said vinylidene-containing polymer is selected from the group consisting of poly(vinylidene fluoride) (PVDF), poly(vinylidene fluoride/vinyl trifluoride) copolymer (poly(VF₂-VF₃)), and blends thereof

19. The method of claim 12, wherein said nylon is selected from the group consisting of Nylon-3, Nylon-5, Nylon-7, Nylon-11, Nylon 5-7, Nylon 3-5, and blends thereof.

20. The method of claim 12, wherein the fine powder blend is formed by mixing said vinylidene-containing polymer and said nylon in a freezer/mill at liquid nitrogen temperature for approximately 30 minutes.

21. The method of claim 12, wherein the blend has a remanent polarization that is greater than that of either said vinylidene-containing polymer or said nylon separately.

22. The method of claim 12, wherein the blend has a remanent polarization that is at least 50% greater than that of either said vinylidene-containing polymer or said nylon separately.

23. The method of claim 12, wherein the blend has a remanent polarization that is at least 70% greater than that of either said vinylidene-containing polymer or said nylon separately.

24. The method of claim 12, wherein the blend comprises a 50:50 by weight blend of said vinylidene-containing polymer and said nylon.

25. The method of claim 12, wherein said vinylidene- containing polymer is Poly(VF₂-VF₃) and said nylon is Nylon-11.

26. The method of claim 12, wherein said vinylidene-containing polymer is PVDF and said nylon is Nylon-11.

27. A piezoelectric film comprising a blend comprising a vinylidene-containing polymer and at least 10% by weight of the blend a nylon selected from the group consisting of odd-numbered nylons and odd-odd numbered nylons, wherein said material retains its polarized properties up to about 160° C.

28. A piezoelectric film formed by a process comprising the following steps:
a) providing a melted fine powder blend comprising a vinylidene-containing polymer and at least 10% by weight a nylon selected from the group consisting of odd-numbered nylons and odd-odd numbered nylons,
b) forming said melted fine powder blend into a film, and
c) polarizing said film.

29. The film of claim 28, wherein said forming of said film further comprises a step of quenching said film.

30. The film of claim 28, wherein said forming of said film further comprises a step of uniaxially drawing said film.

31. The film of claim 28, wherein said polarizing is in a field of 220 MV/m.

32. The film of claim 28, wherein the fine powder blend is formed by mixing said vinylidene-containing polymer and said nylon. in a freezer/mill at liquid nitrogen temperature for approximately thirty minutes.

33. A multi-layered piezoelectric film comprising at least two piezoelectric films, said films comprising a blend comprising a vinylidene-containing polymer and at least 10% by weight of the blend a nylon selected from the group consisting of odd-numbered nylons and odd-odd numbered nylons, wherein said material retains its polarized properties up to about 160° C.

34. A multi-layered piezoelectric filmed formed by laminating at least two piezoelectric films, said films formed by a process comprising the following steps:
a) providing a melted fine powder blend comprising a vinylidene-containing polymer and at least 10% by weight a nylon selected from the group consisting of odd-numbered nylons and odd-odd numbered nylons,
b) forming said melted fine powder blend into a film, and
c) polarizing said film.
